(19) United States
(12) Patent Application Publication
(10) Pub. No.: US 2025/0188363 A1
(43) Pub. Date: Jun. 12, 2025

(54) RECOVERY OF HEAT FROM PYROLYSIS FLUE GAS

(71) Applicant: Eastman Chemical Company, Kingsport, TN (US)

(72) Inventors: David Eugene Slivensky, Tatum, TX (US); Daryl Bitting, Longview, TX (US); Xianchun Wu, Longview, TX (US)

(73) Assignee: Eastman Chemical Company, Kingsport, TN (US)

(21) Appl. No.: 18/845,490

(22) PCT Filed: Mar. 15, 2023
(86) PCT No.: PCT/US2023/064371

§ 371 Date: Sep. 10, 2024

Related U.S. Application Data
(60) Provisional application No. 63/269,482, filed on Mar. 17, 2022.

(51) Int. Cl. C10G 1/10; C10G 9/38

(52) U.S. Cl. CPC C10G 1/10; C10G 9/38; C10G 2300/1003

(57) ABSTRACT

It has been discovered that heat energy may be captured from the flue gas from a pyrolysis reactor, which was previously lost due to exhausting. More particularly, it has been discovered that residual heat energy from pyrolysis flue gas in a chemical recycling facility may be used to preheat waste plastic streams and provide heat for waste plastic pyrolysis. Consequently, the pyrolysis processes and systems described herein may obtain a lower carbon footprint.

### BACKGROUND

Waste plastic pyrolysis plays a part in a variety of chemical recycling technologies. The pyrolysis of waste plastic produces heavy components (e.g., waxes, tar, and char), as well as recycle content pyrolysis oil (r-pyoil) and recycle content pyrolysis gas (r-pygas). When the pyrolysis facility is located near another processing facility, such as a cracker facility, it is desirable to send as much of the r-pyoil and r-pygas as possible to the downstream processing facility to be used as a feedstock in forming other recycle content products (e.g., olefins, paraffins, etc.).

However, the combustion of fossil fuels is typically used to provide the heat to melt the waste plastics for the pyrolysis reaction and for the pyrolysis reaction itself. Consequently, this combustion of fossil fuels can increase CO₂ emissions. In other words, the present methods for melting the waste plastics and waste plastic pyrolysis generally requires the combustion of fossil fuels, which negatively affects the carbon footprint of the chemical recycling facility. Thus, a heat processing scheme for waste plastic pyrolysis that provides a lower carbon footprint is needed.

### SUMMARY

In one aspect, the present technology concerns a chemical recycling process. Generally, the process comprises: (a) pyrolyzing a feedstock comprising a liquefied waste plastic to produce a pyrolysis effluent stream, wherein the pyrolyzing comprises combusting a pyrolysis fuel to thereby form a pyrolysis flue gas and provide heat for the pyrolyzing; (b) liquefying at least a portion of a waste plastic in a liquification system to form the liquefied waste plastic, wherein at least a portion of the heat used for the liquefying of the waste plastic is recovered from the pyrolysis flue gas; and (c) further heating at least a portion of the liquefied waste plastic, wherein at least a portion of the heat used for the further heating is recovered from the pyrolysis flue gas.

In one aspect, the present technology concerns a chemical recycling process. Generally, the process comprises: (a) pyrolyzing a feedstock comprising a liquefied waste plastic to produce a pyrolysis effluent stream, wherein the pyrolyzing comprises combusting a pyrolysis fuel to thereby form a pyrolysis flue gas and provide heat for the pyrolyzing; (b) liquefying at least a portion of a waste plastic in a liquification system to form the liquefied waste plastic and a halogen-containing waste stream, wherein at least a portion of the heat used for the liquefying of the waste plastic is recovered from the pyrolysis flue gas; (c) further heating at least a portion of the liquefied waste plastic in a convection section, wherein at least a portion of the heat used for the further heating is recovered from the pyrolysis flue gas; and (d) recovering a carbon dioxide stream from at least a portion of the pyrolysis flue gas after the liquefying of step (b) and the further heating of step (c).

### BRIEF DESCRIPTION OF THE DRAWINGS

FIG. 1 is a block flow diagram illustrating the main steps of a process and facility for chemically recycling waste plastic and reutilizing heat from the pyrolysis flue gas according to embodiments of the present technology;

FIG. 2 is a block flow diagram illustrating the main steps of a process and facility for chemically recycling waste plastic and reutilizing heat from the pyrolysis flue gas according to embodiments of the present technology; and

FIG. 3 is a block flow diagram illustrating the main steps of a process and facility for chemically recycling waste plastic and reutilizing heat from the pyrolysis flue gas according to embodiments of the present technology.

### DETAILED DESCRIPTION

We have discovered that heat energy may be recovered from the pyrolysis flue gas from the pyrolysis reactor, which was previously lost due to exhausting. More particularly, we have discovered that the heat energy from pyrolysis flue gas may be used, along with a convection box 16, to preheat waste plastic streams and provide heat for waste plastic pyrolysis. Consequently, the pyrolysis processes and systems described herein may obtain a lower carbon footprint.

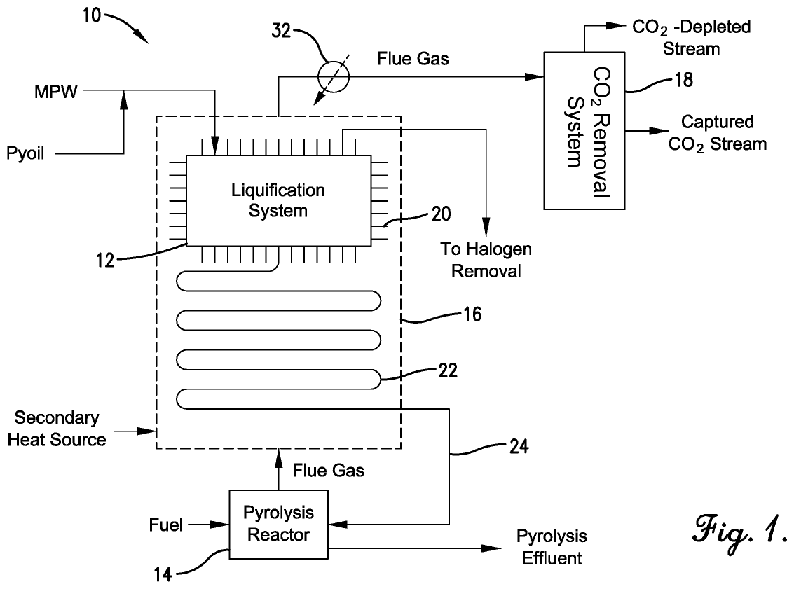

FIG. 1 depicts an exemplary chemical recycling facility 10 comprising a pyrolysis facility (e.g., the plastic liquification system 12 and the pyrolysis reactor 14). As noted above, the chemical recycling facility 10 described herein can recover heat energy from the pyrolysis flue gas, which is typically reserved for exhaustion, and use this heat energy to preheat waste plastic streams and provide heat for the waste plastic pyrolysis. As depicted in FIG. 1, the pyrolysis facility can utilize a convection box 16 to recover heat energy from the pyrolysis flue gas and apply this additional heat energy at different points within the liquification and pyrolysis processes. It should be understood that FIG. 1 depicts one exemplary embodiment of the present technology. Certain features depicted in FIG. 1 may be omitted and/or additional features described elsewhere herein may be added to the system depicted in FIG. 1. The various process steps are described below in greater detail.

### Overall Chemical Recycling Facility

Turning now to FIG. 1, the main steps of a process for chemically recycling waste plastic in a chemical recycling facility 10 are shown. Chemical recycling processes and facilities as described herein may be used to convert waste plastic to recycle content products or chemical intermediates used to form a variety of end use materials. As shown in FIG. 1, the waste plastic fed to the chemical recycling facility/process can be mixed plastic waste (MPW), pre-sorted waste plastic, and/or pre-processed waste plastic.

In an embodiment or in combination with any embodiment mentioned herein, the chemical recycling facility 10 may be a commercial-scale facility capable of processing significant volumes of mixed plastic waste. As used herein, the term “commercial scale facility” refers to a facility having an average annual feed rate of at least 500 pounds per hour, averaged over one year.

In an embodiment or in combination with any embodiment mentioned herein, the chemical recycling facility 10 may comprise two or more facilities, such as a pyrolysis facility (e.g., the pyrolysis reactor 14 and the plastic liquification system 12 depicted in FIGS. 1-3) and a CO₂ removal facility 18, that are co-located with one another. As used herein, the term “co-located” refers to facilities in which at least a portion of the process streams and/or supporting equipment or services are shared between the two facilities. When two or more of the facilities are co-located, the facilities may meet at least one of the following criteria (i) through (v): (i) the facilities share at least one non-residential utility service; (ii) the facilities share at least one service group; (iii) the facilities are owned and/or operated by parties that share at least one property boundary; (iv) the facilities are connected by at least one conduit configured to carry at least one process material (e.g., solid, liquid and/or gas fed to, used by, or generated in a facility) from one facility to another; and (v) the facilities are within 40, within 35, within 30, within 20, within 15, within 12, within 10, within 8, within 5, within 2, or within 1 mile of one another, measured from their geographical center. At least one, at least two, at least three, at least four, or all of the above statements (i) through (v) may be true.

Regarding (i), examples of suitable utility services include, but are not limited to, steam systems (co-generation and distribution systems), cooling water systems, heat transfer fluid systems, plant or instrument air systems, nitrogen systems, hydrogen systems, non-residential electrical generation and distribution, including distribution above 8000V, non-residential wastewater/sewer systems, storage facilities, transport lines, flare systems, and combinations thereof.

Regarding (ii), examples of service groups and facilities include, but are not limited to, emergency services personnel (fire and/or medical), a third-party vendor, a state or local government oversight group, and combinations thereof. Government oversight groups can include, for example, regulatory or environmental agencies, as well as municipal and taxation agencies at the city, county, and state level.

Regarding (iii), the boundary may be, for example, a fence line, a property line, a gate, or common boundaries with at least one boundary of a third-party owned land or facility.

Regarding (iv), the conduit may be a fluid conduit that carries a gas, a liquid, a solid/liquid mixture (e.g., slurry), a solid/gas mixture (e.g., pneumatic conveyance), a solid/liquid/gas mixture, or a solid (e.g., belt conveyance). In some cases, two units may share one or more conduits selected from the above list.

Turning again to FIG. 1, a stream of waste plastic, which can be mixed plastic waste (MPW), may be introduced into the chemical recycling facility 10 from a waste plastic source. As used herein, the terms “waste plastic” and “plastic waste” refer to used, scrap, and/or discarded plastic materials, such as plastic materials typically sent to a landfill. The waste plastic stream fed to the chemical recycling facility 10 may include unprocessed or partially processed waste plastic. As used herein, the term “unprocessed waste plastic” means waste plastic that has not be subjected to any automated or mechanized sorting, washing, or comminuting. Examples of unprocessed waste plastic include waste plastic collected from household curbside plastic recycling bins or shared community plastic recycling containers. Partially processed waste plastics may originate from, for example, municipal recycling facilities (MRFs) or reclaimers. In certain embodiments, the waste plastic may comprise at least one of post-industrial (or pre-consumer) plastic and/or post-consumer plastic.

In an embodiment or in combination with any embodiment mentioned herein, the mixed waste plastic (MPW) includes at least two distinct types of plastic.

In an embodiment or in combination with any embodiment mentioned herein, all or a portion of the MPW in the waste plastic stream can originate from a municipal recycling facility (MRF).

In an embodiment or in combination with any embodiment mentioned herein, all or a portion of the MPW in the waste plastic stream can originate from a reclaimer facility.

Examples of suitable waste plastics can include, but are not limited to, polyolefins (PO), aromatic and aliphatic polyesters, polyvinyl chloride (PVC), polystyrene, cellulose esters, polytetrafluoroethylene, acrylobutadienestyrene (ABS), cellulosics, epoxides, polyamides, phenolic resins, polyacetal, polycarbonates, polyphenylene-based alloys, poly (methyl methacrylate), styrene-containing polymers, polyurethane, vinyl-based polymers, styrene acrylonitrile, and urea-containing polymers and melamines.

Examples of specific polyolefins may include linear low-density polyethylene (LLDPE), low density polyethylene (LDPE), polymethylpentene, polybutene-1, high density polyethylene (HDPE), atactic polypropylene, isotactic polypropylene, syndiotactic polypropylene, crosslinked polyethylene, amorphous polyolefins, and the copolymers of any one of the aforementioned polyolefins.

Examples of polyesters can include those having repeating aromatic or cyclic units such as those containing a repeating terephthalate, isophthalate, or naphthalate units such as PET, modified PET, and PEN, or those containing repeating furanate repeating units. As used herein, “PET” or “polyethylene terephthalate” refers to a homopolymer of polyethylene terephthalate, or to a polyethylene terephthalate modified with one or more acid and/or glycol modifiers and/or containing residues or moieties of other than ethylene glycol and terephthalic acid, such as isophthalic acid, 1,4-cyclohexanedicarboxylic acid, diethylene glycol, 2,2,4,4-tetramethyl-1,3-cyclobutanediol (TMCD), cyclohexanedimethanol (CHDM), propylene glycol, isosorbide, 1,4-butanediol, 1,3-propane diol, and/or neopentyl glycol (NPG).

In an embodiment or in combination with any embodiment mentioned herein, the waste plastic stream comprises at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent of one or more polyolefins, based on the total weight of the stream. Alternatively, or in addition, the waste plastic stream comprises not more than 99.9, not more than 99, not more than 97, not more than 92, not more than 90, not more than 85, not more than 80, not more than 75, not more than 70, not more than 65, not more than 60, not more than 55, not more than 50, not more than 45, not more than 40, not more than 35, not more than 30, not more than 25, not more than 20, not more than 15, not more than 10, or not more than 5 weight percent of one or more polyolefins, based on the total weight of the stream.

In one embodiment or in combination with any of the mentioned embodiments, the waste plastic stream comprises not more than 20, not more than 15, not more than 12, not more than 10, not more than 8, not more than 6, not more than 5, not more than 4, not more than 3, not more than 2, or not more than 1 weight percent of polyesters, based on the total weight of the stream.

In one embodiment or in combination with any of the mentioned embodiments, the waste plastic stream comprises not more than 20, not more than 15, not more than 12, not more than 10, not more than 8, not more than 6, not more than 5, not more than 4, not more than 3, not more than 2, or not more than 1 weight percent of biowaste materials, based on the total weight of the stream. As used herein, the term “biowaste” refers to material recovered from living organisms or of organic origin. Exemplary biowaste materials include, but are not limited to, cotton, wood, saw dust, food scraps, animals and animal parts, plants and plant parts, and manure.

In an embodiment or in combination with any embodiment mentioned herein, the waste plastic stream can include not more than 10, not more than 5, not more than 4, not more than 3, not more than 2, not more than 1, not more than 0.75, or not more than 0.5 weight percent of polyvinyl chloride (PVC), based on the total weight of the stream.

The general configuration and operation of each of the facilities that may be present in the chemical recycling facility 10 shown in FIG. 1 will now be described in further detail below, beginning with the optional preprocessing facility of the waste plastic source.

### Optional Plastic Preprocessing

As shown in FIG. 1, unprocessed, partially processed, and/or processed waste plastic, such as mixed plastic waste (MPW), may first be introduced into the chemical recycling facility 10 from a waste plastic source. The waste plastic source may include an optional preprocessing facility that can prepare the waste plastic feedstock for the downstream recycling processes. While in the optional preprocessing facility, the waste plastic feedstock may undergo one or more preprocessing steps to prepare it for chemical recycling. As used herein, the term “preprocessing facility” refers to a facility that includes all equipment, lines, and controls necessary to carry out the preprocessing of waste plastic. Preprocessing facilities as described herein may employ any suitable method for carrying out the preparation of waste plastic for chemical recycling using one or more of following steps, which are described in further detail below. Alternatively, in certain embodiments, the waste plastic source does not contain a preprocessing facility and the waste plastic stream is not subjected to any preprocessing before any of the downstream chemical recycling steps described herein.

In an embodiment or in combination with any embodiment mentioned herein, the preprocessing facility of the waste plastic source may include at least one separation step or zone. The separation step or zone may be configured to separate the waste plastic stream into two or more streams enriched in certain types of plastics. Such separation is particularly advantageous when the waste plastic fed to the chemical recycling facility 10 is MWP.

Any suitable type of separation device, system, or facility may be employed to separate the waste plastic into two or more streams enriched in certain types of plastics such as, for example, a PET-enriched stream and a PO-enriched stream. Examples of suitable types of separation include mechanical separation and density separation, which may include sink-float separation and/or centrifugal density separation. As used herein, the term “sink-float separation” refers to a density separation process where the separation of materials is primarily caused by floating or sinking in a selected liquid medium, while the term “centrifugal density separation” refers to a density separation process where the separation of materials is primarily caused by centrifugal forces.

Referring again to FIG. 1, the waste plastic stream may be introduced into one or more downstream processing facilities (or undergo one or more downstream processing steps) within the chemical recycling facility 10. In an embodiment or in combination with any embodiment mentioned herein, at least a portion of the waste plastic stream may be directly or indirectly introduced into a plastic liquification system 12 within the waste plastic source or outside of it. Additional details of each step, as well as the general integration of each of these steps or facilities with one or more of the others according to one or more embodiments of the present technology are discussed in further detail below.

### Liquification/Dehalogenation

As shown in FIG. 1, the waste plastic stream may be introduced into a plastic liquification system 12 prior to being introduced into the pyrolysis reactor 14. As used herein, the term “liquification” system refers to a chemical processing zone or step in which at least a portion of the incoming plastic is liquefied. The step of liquefying plastic in FIG. 1 can include chemical liquification, physical liquification, or combinations thereof. Exemplary methods of liquefying the plastic introduced in the liquification system 12 can include: (i) heating/melting; (ii) dissolving in a solvent; (iii) depolymerizing; (iv) plasticizing; and combinations thereof. Additionally, one or more of options (i) through (iv) may also be accompanied by the addition of a blending or liquification agent to help facilitate the liquification (reduction of viscosity) of the polymer material. As such, a variety of rheology modification agents (e.g., solvents, depolymerization agents, plasticizers, and blending agents) can be used the enhance the flow and/or dispersibility of the liquified waste plastic.

When added to the liquification system 12, at least 50, at least 55,at least 60, at least 65, at least 70, at least 75, at least 80, at least 85, at least 90, at least 95, or at least 99 weight percent of the plastic (usually waste plastic) originally present in the waste plastic stream undergoes a reduction in viscosity. In some cases, the reduction in viscosity can be facilitated by heating (e.g., addition of steam directly or indirectly contacting the plastic), while, in other cases, it can be facilitated by combining the plastic with a solvent capable of dissolving it. Examples of suitable solvents can include, but are not limited to, alcohols such as methanol or ethanol, glycols such as ethylene glycol, diethylene glycol, triethylene glycol, neopentyl glycol, cyclohexanedimethanol, glycerin, pyrolysis oil, motor oil, and water. This dissolution solvent can be added directly to the liquification vessel in the liquification system 12, or it can be previously combined with one or more streams fed to the liquification system 12, including the waste plastic stream.

In an embodiment or in combination with any embodiment mentioned herein, the dissolution solvent can comprise a stream withdrawn from one or more other facilities within the chemical recycling facility 10. For example, the solvent can comprise a stream withdrawn from the pyrolysis reactor 14. In certain embodiments, the dissolution solvent can be or comprise pyrolysis oil.

In some cases, the waste plastic can be depolymerized such that, for example, the number average chain length of the plastic is reduced by contact with a depolymerization agent. In an embodiment or in combination with any embodiment mentioned herein, at least one of the previously-listed solvents may be used as a depolymerization agent, while, in one or more other embodiments, the depolymerization agent can include an organic acid (e.g., acetic acid, citric acid, butyric acid, formic acid, lactic acid, oleic acid, oxalic, stearic acid, tartaric acid, and/or uric acid) or inorganic acid such as sulfuric acid (for polyolefins). The depolymerization agent may reduce the melting point and/or viscosity of the polymer by reducing its number average chain length.

Alternatively, or additionally, a plasticizer can be used in the liquification system 12 to reduce the viscosity of the plastic. Plasticizers for polyethylene include, for example, dioctyl phthalate, dioctyl terephthalate, glyceryl tribenzoate, polyethylene glycol having molecular weight of up to 8,000 Daltons, sunflower oil, paraffin wax having molecular weight from 400 to 1,000 Daltons, paraffinic oil, mineral oil, glycerin, EPDM, and EVA.

Plasticizers for polypropylene include, for example, dioctyl sebacate, paraffinic oil, isooctyl tallate, plasticizing oil (Drakeol 34), naphthenic and aromatic processing oils, and glycerin. Plasticizers for polyesters include, for example, polyalkylene ethers (e.g., polyethylene glycol, polytetramethylene glycol, polypropylene glycol or their mixtures) having molecular weight in the range from 400 to 1500 Daltons, glyceryl monostearate, octyl epoxy soyate, epoxidized soybean oil, epoxy tallate, epoxidized linseed oil, polyhydroxyalkanoate, glycols (e.g., ethylene glycol, pentamethylene glycol, hexamethylene glycol, etc.), phthalates, terephthalates, trimellitate, and polyethylene glycol di-(2-ethylhexoate). When used, the plasticizer may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the waste plastic stream, or it can be in a range of from 0.1 to 10 weight percent, 0.5 to 8 weight percent, or 1 to 5 weight percent, based on the total weight of the waste plastic stream.

Further, one or more of the methods of liquefying the waste plastic stream can also include adding at least one blending agent to the plastic stream before, during, or after the liquification process in the liquification system 12. Such blending agents may include for example, emulsifiers and/or surfactants, and may serve to more fully blend the liquified plastic into a single phase, particularly when differences in densities between the plastic components of a mixed plastic stream result in multiple liquid or semi-liquid phases. When used, the blending agent may be present in an amount of at least 0.1, at least 0.5, at least 1, at least 2, or at least 5 weight percent and/or not more than 10, not more than 8, not more than 5, not more than 3, not more than 2, or not more than 1 weight percent, based on the total weight of the waste plastic stream, or it can be in a range of from 0.1 to 10 weight percent, 0.5 to 8 weight percent, or 1 to 5 weight percent, based on the total weight of the waste plastic stream.

In an embodiment or in combination with any embodiment mentioned herein, a portion of a pyrolysis oil from the pyrolysis reactor 14 can be combined with the waste plastic stream to form a liquified plastic. Generally, as shown in FIGS. 1-3, all or a portion of the pyrolysis oil may be combined with the waste plastic stream prior to introduction into the liquification system 12, or after the waste plastic stream enters the liquification vessel within the liquification system 12.

In an embodiment or in combination with any embodiment mentioned herein, the liquified (or reduced viscosity) plastic stream withdrawn from the liquification system 12 can include at least 1, at least 5, at least 10, at least 15, at least 20, at least 25, at least 30, at least 35, at least 40, at least 45, at least 50, at least 55, at least 60, at least 65, at least 70, at least 75, at least 80, at least 85, at least 90, at least 95, or at least 99 weight percent and/or not more than 95, not more than 90, not more than 85, not more than 80, not more than 75, not more than 70, not more than 65, not more than 60,not more than 55, not more than 50, not more than 45, not more than 40, not more than 35, not more than 30, not more than 25, not more than 20, not more than 15, not more than 10, not more than 5, not more than 2, or not more than 1 weight percent of one or more polyolefins, based on the total weight of the stream, or the amount of polyolefins can be in the range of from 1 to 99 weight percent, 5 to 90 weight percent, or 10 to 85 weight percent, based on the total weight of the stream.

In an embodiment or in combination with any embodiment mentioned herein, the liquified plastic stream exiting the plastic liquification system 12 can have a viscosity of less than 3,000, less than 2,500, less than 2,000, less than 1,500, less than 1,000, less than 800, less than 750, less than 700, less than 650, less than 600, less than 550, less than 500, less than 450, less than 400, less than 350, less than 300, less than 250, less than 150, less than 100, less than 75, less than 50, less than 25, less than 10, less than 5, or less than 1 poise, as measured using a Brookfield R/S rheometer with a V80-40 vane spindle operating at a shear rate of 10 rad/s and a temperature of 350° C.

In an embodiment or in combination with any embodiment mentioned herein, the plastic liquification system 12 may comprise at least one liquification vessel to facilitate the liquefying of the waste plastics. In various embodiments, the liquification vessel can include at least one melt tank and/or at least one extruder to facilitate the plastic liquification. Additionally, in certain embodiments, the liquification system 12 may also contain at least one stripping column and at least one disengagement vessel to facilitate the removal of halogenated compounds that may be formed in the liquification vessel.

In an embodiment or in combination with any embodiment mentioned herein, the melt tank can include one or more continuously stirred tanks. When one or more rheology modification agents (e.g., solvents, depolymerization agents, plasticizers, and blending agents) are used in the liquification system 12, such rheology modification agents can be added to and/or mixed with the waste plastic stream in or prior to introduction into the melt tank.

In an embodiment or in combination with any embodiment mentioned herein, the liquification vessel, such as the melt tank and/or the extruder, may receive the waste plastic feed stream and heat the waste plastic via heating mechanisms in the melt tank and/or via the extrusion process in the extruder.

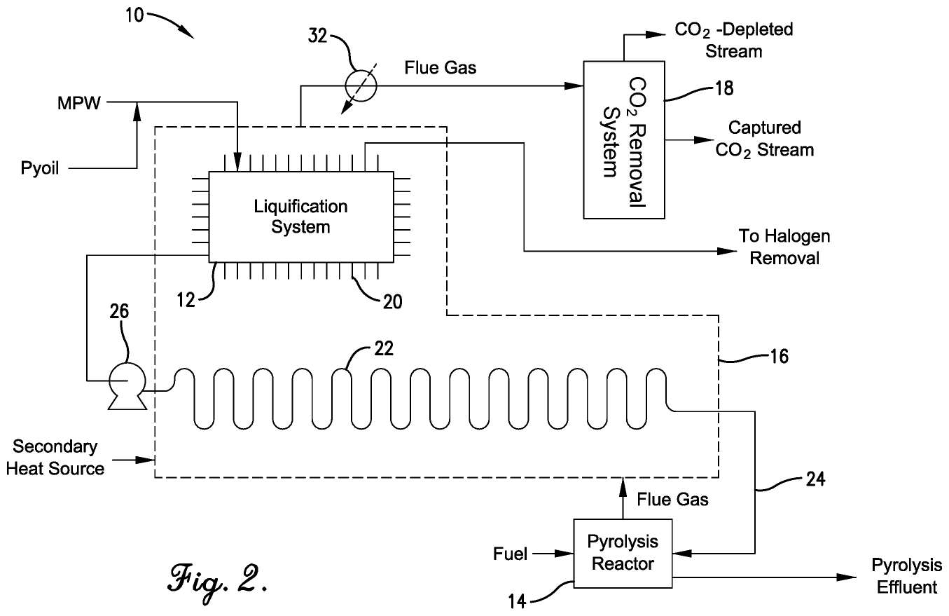

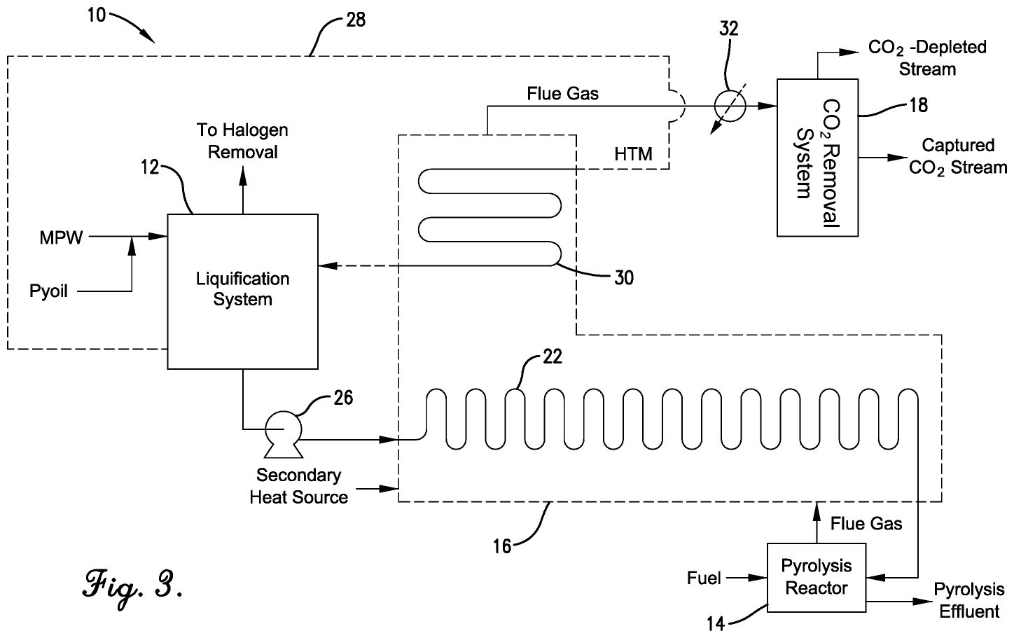

Furthermore, as described below in greater detail, the liquification system 12, such as the liquification vessel, may be at least partially heated by being placed in a convection box 16 that is at least partially heated by the pyrolysis flue gas. More particularly, as described in greater detail below in regard to FIGS. 1 and 2, the liquification system 12 may be positioned within a convection box 16 that is at least partially heated by the pyrolysis flue gas and an optional secondary heat source. Alternatively, in certain embodiments and as depicted in FIG. 3, the liquification system 12 may be placed outside of a convection box 16 and at least partially heated by heat transfer medium loop with a heat transfer medium (HTM). These aforementioned embodiments involving the convection box 16 are described in greater detail below.

In an embodiment or in combination with any embodiment mentioned herein, the liquification vessel, such as the melt tank and/or the extruder, may comprise a plurality of fins 20 to increase the surface area of the liquification vessel for heat transfer purposes. More particularly, as shown in FIGS. 1 and 2, the liquification system 12, such as the liquification vessel, may comprise a plurality of fins 20 that increase the exterior surface area of the liquification system 12, which can facilitate heat transfer from the pyrolysis flue gas in the convection box 16.

In an embodiment or in combination with any embodiment mentioned herein, the liquification vessel, such as the melt tank and/or the extruder, may be at least partially heated by a combustion system comprising a plurality a burners that combust a combustion fuel and a combustion air. In an embodiment or in combination with any embodiment

mentioned herein, the interior space of the liquification vessel, where the plastic is heated, is maintained at a temperature of at least 200, at least 210, at least 220, at least 230, at least 240, at least 250, at least 260, at least 270, at least 280, at least 290, at least 300, at least 310, at least 320, at least 330, at least 340, at least 350, at least 360, at least 370, at least 380, at least 390, or at least 400° C. Additionally, or in the alternative, the interior space of the liquification vessel may be maintained at a temperature of not more than 500, not more than 475, not more than 450, not more than 425, not more than 400, not more than 390, not more than 380, not more than 370, not more than 365, not more than 360, not more than 355, not more than 350, or not more than 345° C. Generally, in one or more embodiments, the interior space of the liquification vessel may be maintained at a temperature ranging from 200 to 500° C., 240 to 425° C., 280 to 380° C., or 320 to 350° C.

In an embodiment or in combination with any embodiment mentioned herein, the liquification system 12 may optionally contain equipment for removing halogens from the waste plastic stream. When the waste plastic is heated in the liquification system 12, halogen-enriched waste gases can evolve. By disengaging the evolved halogen-enriched gasses from the liquified plastics, the concentration of halogens in the liquified plastic stream can be reduced. As shown in FIG. 1, at least a portion of the resulting halogen-containing may be removed from the facility for further treatment in a halogen removal system to thereby form a halogen-depleted stream and a halogen-enriched stream.

In an embodiment or in combination with any embodiment mentioned herein, dehalogenation can be promoted by sparging a stripping gas (e.g., steam) into the liquified plastics in the melt tank. In an embodiment or in combination with any embodiment

mentioned herein, the liquified plastic stream exiting the liquification system 12 can have a halogen content of less than 500, less than 400, less than 300, less than 200, less than 100, less than 50, less than 10, less than 5, less tha n 2, less than 1, less than 0.5, or less than 0.1 ppmw.

In an embodiment or in combination with any embodiment mentioned herein, the halogen content of the liquified plastic stream exiting the liquification system 12 can be not more than 95, not more than 90, not more than 75, not more than 50, not more than 25, not more than 10, or not more than 5 percent by weight of the halogen content of the waste plastic stream introduced into the liquification system 12.

In an embodiment or in combination with any embodiment mentioned herein, the liquefied waste plastic stream exiting the plastic liquification system 12 may have a temperature of at least 200, at least 225, at least 250, at least 275, at least 300, at least 310, at least 320, at least 330, or at least 340° C. and/or less than 450, less than 425, less than 400, less than 375, or less than 350° C.

As shown in FIGS. 1-3, and described below in greater detail, the liquefied plastic stream exiting the liquification system 12 may be further heated by passing the stream through one or more warming passes through a convection box 16 heated by the pyrolysis flue gas. While in these warming passes (shown as tubes 22 in FIGS. 1-3), the liquefied waste plastic can be heated via indirect heat exchange with the pyrolysis flue gas. Generally, these warming passes may be in the form a brazed aluminum heat exchanger comprising a plurality of warming passes disposed in the convection box 16 for facilitating indirect heat exchange between the liquefied plastic stream and the heat energy retained in the convection box 16. This additional heating step can take advantage of the excess heat energy provided by the pyrolysis flue gas. Consequently, the liquefied plastic stream may be further heated prior to the downstream pyrolysis process, thereby lowering the heat energy requirements of the pyrolysis reaction.

As shown in FIGS. 1-3, after being further being further heated via indirect heat exchange in the warming passes within the convection box 16, at least a portion of the heated liquefied plastic stream may be introduced into a downstream pyrolysis reactor 14 at a pyrolysis facility to produce a pyrolysis effluent, including a pyrolysis oil and a pyrolysis gas.

### Pyrolysis

As shown in FIG. 1, the chemical recycling facility 10 may comprise a pyrolysis reactor 14. As used herein, the term “pyrolysis” refers to thermal decomposition of a feedstock of a biomass and/or a plastic material in solid or liquid form at elevated temperatures in an inert (i.e., substantially molecular oxygen free) atmosphere. A “pyrolysis facility” is a facility that includes all equipment, lines, and controls necessary to carry out pyrolysis of waste plastic and feedstocks derived therefrom. In certain embodiments, the pyrolysis facility can comprise the pyrolysis reactor 14 and, optionally, the plastic liquification system 12.

As depicted in FIG. 1, the liquified plastic stream may be introduced into a downstream pyrolysis reactor 14 at a pyrolysis facility so as to produce a pyrolysis effluent stream comprising a pyrolysis oil, a pyrolysis gas, and a pyrolysis residue.

In an embodiment or in combination with any embodiment mentioned herein, the liquified plastic stream to the pyrolysis facility may be a PO-enriched stream of waste plastic. The liquified plastic stream introduced into the pyrolysis reactor 14 can be in the form of liquified plastic (e.g., liquified, melted, plasticized, depolymerized, or combinations thereof), plastic pellets or particulates, or a slurry thereof.

In general, the pyrolysis facility may include the plastic liquification system 12, the pyrolysis reactor 14, and a separation system (not shown in FIGS. 1-3) for the pyrolysis effluent, which can separate the pyrolysis effluent into a pyrolysis gas stream, a pyrolysis oil stream, and/or a pyrolysis residue stream.

While in the pyrolysis reactor 14, at least a portion of the feed may be subjected to a pyrolysis reaction that produces a pyrolysis effluent comprising a pyrolysis oil, a pyrolysis gas, and a pyrolysis residue. Generally, the pyrolysis effluent stream exiting the pyrolysis reactor 14 can be in the form of pyrolysis vapors that comprise the pyrolysis gas and uncondensed pyrolysis oil. As used herein, “pyrolysis vapor” refers to the uncondensed pyrolysis effluent that comprises the majority of the pyrolysis oil and the pyrolysis gas present in the pyrolysis effluent.

Pyrolysis is a process that involves the chemical and thermal decomposition of the introduced feed. Although all pyrolysis processes may be generally characterized by a reaction environment that is substantially free of oxygen, pyrolysis processes may be further defined, for example, by the pyrolysis reaction temperature within the reactor, the residence time in the pyrolysis reactor 14, the reactor type, the pressure within the pyrolysis reactor 14, and the presence or absence of pyrolysis catalysts.

In an embodiment or in combination with any embodiment mentioned herein, the pyrolysis reactor 14 can be, for example, a film reactor, a screw extruder, a tubular reactor, a tank, a stirred tank reactor, a riser reactor, a fixed bed reactor, a fluidized bed reactor, a rotary kiln, a vacuum reactor, a microwave reactor, or an autoclave.

In an embodiment or in combination with any embodiment mentioned herein, a lift gas and/or a feed gas may be used to introduce the feedstock into the pyrolysis reactor 14 and/or facilitate various reactions within the pyrolysis reactor 14. For instance, the lift gas and/or the feed gas may comprise, consist essentially of, or consist of nitrogen, carbon dioxide, and/or steam. The lift gas and/or feed gas may be added with the waste plastic stream prior to introduction into the pyrolysis reactor 14 and/or may be added directly to the pyrolysis reactor 14. The lift gas and/or feed gas can include steam and/or a reducing gas such as hydrogen, carbon monoxide, and combinations thereof.

Furthermore, the temperature in the pyrolysis reactor 14 can be adjusted so as to facilitate the production of certain end products. In an embodiment or in combination with any embodiment mentioned herein, the pyrolysis temperature in the pyrolysis reactor 14 can range from 325 to 1,100° C., 350 to 900° C., 350 to 700° C., 350 to 550° C., 350 to 475° C., 425 to 1,100° C., 425 to 800° C., 500 to 1,100° C., 500 to 800° C., 600 to 1,100° C., 600 to 800° C., 625 to 1,000° C., 700 to 1,000° C., or 625 to 800° C. Generally, in certain embodiments, the pyrolysis temperature in the pyrolysis reactor 14 can be greater than 625° C.

In an embodiment or in combination with any embodiment mentioned herein, the residence times of the feedstocks within the pyrolysis reactor 14 can be at least 0.1, at least 0.2, at least 0.3, at least 0.5, at least 1, at least 1.2, at least 1.3, at least 2, at least 3, or at least 4 seconds. Alternatively, the residence times of the feedstocks within the pyrolysis reactor 14 can be at least 1, at least 2, at least 3, at least 4, at least 5, at least 6, at least 7, at least 8, at least 9, at least 10, at least 20, at least 30, at least 45, at least 60, at least 75, or at least 90 minutes. Additionally, or alternatively, the residence times of the feedstocks within the pyrolysis reactor 14 can be less than 6, less than 5, less than 4, less than 3, less than 2, less than 1, or less than 0.5 hours. Furthermore, the residence times of the feedstocks within the pyrolysis reactor 14 can be less than 100, less than 90, less than 80, less than 70, less than 60, less than 50, less than 40, less than 30, less than 20, less than 10, less than 9, less than 8, less than 7, less than 6, less than 5, less than 4, less than 3, less than 2, or less than 1 seconds. More particularly, the residence times of the feedstocks within the pyrolysis reactor 14 can range from 0.1 to 10 seconds, 0.5 to 10 seconds, 30 minutes to 4 hours, or 30 minutes to 3 hours, or 1 hour to 3 hours, or 1 hour to 2 hours.

In an embodiment or in combination with any embodiment mentioned herein, the pressure within the pyrolysis reactor 14 can be maintained at atmospheric pressure or within the range of 0.1 to 100 bar, or 0.1 to 60 bar, or 0.1 to 30 bar, or 0.1 to 10 bar, 0.2 to 1.5 bar, or 0.3 to 1.1 bar. As used herein, the term “bar” refers to gauge pressure, unless otherwise noted.

In an embodiment or in combination with any embodiment mentioned herein, a pyrolysis catalyst may be introduced into the liquified plastic stream prior to introduction into the pyrolysis reactor 14 and/or introduced directly into the pyrolysis reactor 14. The catalyst can be homogenous or heterogeneous and may include, for example, certain types of zeolites and other mesostructured catalysts. In some embodiments, the pyrolysis reaction may not be catalyzed (e.g., carried out in the absence of a pyrolysis catalyst), but may include a non-catalytic, heat-retaining inert additive, such as sand, in the reactor in order to facilitate the heat transfer. Such catalyst-free pyrolysis processes may be referred to as “thermal pyrolysis.”

In an embodiment or in combination with any embodiment mentioned herein, the pyrolysis reactor 14 may be at least partially heated by a combustion system comprising a plurality a burners that combust a combustion fuel and a combustion air. Furthermore, this combustion system may produce a flue gas stream that can be removed from the pyrolysis reactor 14. The combustion fuel may comprise a conventional fossil fuel and/or a recycle content fuel, such as recycle content alkanes (e.g., r-methane) and/or recycle content hydrogen derived from the chemical recycling facility 10.

After exiting the pyrolysis reactor 14, the pyrolysis effluent may be separated into the pyrolysis oil stream and the pyrolysis gas stream in a separation system. Although not depicted in FIGS. 1-3, this separation system can include various types of equipment including, but not limited to a filter system, a multistage separator, a condensation zone, a distillation column, and/or a quench tower. While in the separation system, the pyrolysis effluent, such as the pyrolysis vapors, may be cooled to condense the pyrolysis oil fraction originally present in the pyrolysis effluent stream. In an embodiment or in combination with any embodiment

mentioned herein, the pyrolysis effluent or pyrolysis vapors from the pyrolysis reactor 14 may comprise at least 1, at least 5, at least 10, at least 15, at least 20, at least 25, at least 30, at least 35, at least 40, at least 45, at least 50, at least 55, at least 60, at least 65, at least 70, or at least 75 weight percent of the pyrolysis oil, based on the total weight of the pyrolysis effluent or pyrolysis vapors. Additionally, or alternatively, the pyrolysis effluent or pyrolysis vapors may comprise not more than 99, not more than 95, not more than 90, not more than 85, not more than 80, not more than 75, not more than 70, not more than 65, not more than 60, not more than 55, not more than 50, not more than 45, not more than 40, not more than 35, not more than 30, or not more than 25 weight percent of the pyrolysis oil, based on the total weight of the pyrolysis effluent or pyrolysis vapors. As discussed above, the pyrolysis oil may be in the form of uncondensed vapors in the pyrolysis effluent upon exiting the heated reactor; however, these vapors may be subsequently condensed into the resulting pyrolysis oil. The pyrolysis effluent or pyrolysis vapors may comprise in the range of 20 to 99 weight percent, 25 to 80 weight percent, 30 to 85 weight percent, 30 to 80 weight percent, 30 to 75 weight percent, 30 to 70 weight percent, or 30 to 65 weight percent of the pyrolysis oil, based on the total weight of the pyrolysis effluent or pyrolysis vapors.

In an embodiment or in combination with any embodiment mentioned herein, the pyrolysis effluent or pyrolysis vapors from the pyrolysis reactor 14 may comprise at least 1, at least 5, at least 10, at least 15, at least 20, at least 25, at least 30, at least 35, at least 40, at least 45, at least 50, at least 55, at least 60, at least 65, at least 70, at least 75, or at least 80 weight percent of the pyrolysis gas, based on the total weight of the pyrolysis effluent or pyrolysis vapors. Additionally, or alternatively, the pyrolysis effluent or pyrolysis vapors may comprise not more than 99, not more than 95, not more than 90, not more than 85, not more than 80, not more than 75, not more than 70, not more than 65, not more than 60, not more than 55, not more than 50, or not more than 45 weight percent of the pyrolysis gas, based on the total weight of the pyrolysis effluent or pyrolysis vapors. The pyrolysis effluent may comprise 1 to 90 weight percent, 10 to 85 weight percent, 15 to 85 weight percent, 20 to 80 weight percent, 25 to 80 weight percent, 30 to 75 weight percent, or 35 to 75 weight percent of the pyrolysis gas, based on the total weight of the stream.

In an embodiment or in combination with any embodiment mentioned herein, the pyrolysis effluent or pyrolysis vapors from the pyrolysis reactor 14 may comprise at least 0.5, at least 1, at least 2, at least 3, at least 4, at least 5, at least 6, at least 7, at least 8, at least 9, or at least 10 weight percent of the pyrolysis residue, based on the total weight of the pyrolysis effluent or pyrolysis vapors. Additionally, or alternatively, the pyrolysis effluent may comprise not more than 60, not more than 50, not more than 40, not more than 30, not more than 25, not more than 20, not more than 15, not more than 10, not more than 9, not more than 8, not more than 7, not more than 6, or not more than 5 weight percent of the pyrolysis residue, based on the total weight of the pyrolysis effluent or pyrolysis vapors. The pyrolysis effluent may comprise in the range of 0.1 to 25 weight percent, 1 to 15 weight percent, 1 to 8 weight percent, or 1 to 5 weight percent of the pyrolysis residue, based on the total weight of the pyrolysis effluent or pyrolysis vapors. This pyrolysis residue may be removed from the pyrolysis reactor 14 (where it may form) and/or separated from the pyrolysis effluent in a downstream separator, such as the condenser.

The resulting pyrolysis oil stream and pyrolysis gas stream may be directly used in various downstream applications based on their formulations. The various characteristics and properties of the pyrolysis oil, pyrolysis gas, and pyrolysis residue are described below. It should be noted that, while all of the following characteristics and properties may be listed separately, it is envisioned that each of the following characteristics and/or properties of the pyrolysis gas, pyrolysis oil, and/or pyrolysis residue are not mutually exclusive and may be combined and present in any combination.

In an embodiment or in combination with any embodiment mentioned herein, the pyrolysis oil may predominantly comprise hydrocarbons having from 4 to 30 carbon atoms per molecule (e.g., C4 to C30 hydrocarbons). As used herein, the term “Cx” or “Cx hydrocarbon,” refers to a hydrocarbon compound including “x” total carbons per molecule, and encompasses all olefins, paraffins, aromatics, heterocyclic, and isomers having that number of carbon atoms. For example, each of normal, iso, and tert-butane and butene and butadiene molecules would fall under the general description “C4.” The pyrolysis oil may have a C4-C30 hydrocarbon content of at least 55, at least 60, at least 65, at least 70, at least 75, at least 80, at least 85, at least 90, or at least 95 weight percent based on the total weight of the pyrolysis oil stream.

In an embodiment or in combination with any embodiment mentioned herein, the pyrolysis oil can predominantly comprise C5 to C25 hydrocarbons, C5 to C22 hydrocarbons, or C5 to C20 hydrocarbons. For example, the pyrolysis oil may comprise at least 55, at least 60, at least 65, at least 70, at least 75, at least 80, at least 85, at least 90, or at least 95 weight percent of C5 to C25 hydrocarbons, C5 to C22 hydrocarbons, or C5 to C20 hydrocarbons, based on the total weight of the pyrolysis oil stream.

In an embodiment or in combination with any embodiment mentioned herein, the pyrolysis oil may have a mid-boiling point in the range of 75 to 250° C., 90 to 225° C., or 115 to 190° C. as measured according to ASTM D-5399. As used herein, “mid-boiling point” refers to the median boiling point temperature of the pyrolysis oil, where 50 percent by volume of the pyrolysis oil boils above the mid-boiling point and 50 percent by volume boils below the mid-boiling point.

In an embodiment or in combination with any embodiment mentioned herein, the boiling point range of the pyrolysis oil may be such that at least 90 percent of the pyrolysis oil boils off at a temperature of 250° C., of 280° C., of 290° C., of 300° C., or of 310° C., as measured according to ASTM D-5399.

As noted above, the pyrolysis conditions, such as temperature, may be controlled so as to maximize the production of certain hydrocarbons and chemical compounds in the resulting pyrolysis gas and pyrolysis oil.

Turning to the pyrolysis gas, the pyrolysis gas can have a methane content in the range of 1 to 50 weight percent, 5 to 50 weight percent, or 15 to 45 weight percent, based on the total weight of the pyrolysis gas stream.

In an embodiment or in combination with any embodiment mentioned herein, the pyrolysis gas can have a C3 and/or C4 hydrocarbon content (including all hydrocarbons having 3 or 4 carbon atoms per molecule) in the range of 10 to 90 weight percent, 25 to 90 weight percent, or 25 to 80 weight percent, based on the total weight of the pyrolysis gas stream.

In an embodiment or in combination with any embodiment mentioned herein, the pyrolysis gas can have a combined ethylene and propylene content of at least 25, at least 40, at least 50, at least 60, at least 70, or at least 75 weight percent, based on the total weight of the pyrolysis gas stream.

Turning to the pyrolysis residue, in an embodiment or in combination with any embodiment mentioned herein, the pyrolysis residue comprises at least 20, at least 25, at least 30, at least 35, at least 40, at least 45, at least 50, at least 55, at least 60, at least 65, at least 70, at least 75, at least 80, or at least 85 weight percent of C20+hydrocarbons based on the total weight of the pyrolysis residue. As used herein, “C20+hydrocarbon” refers to hydrocarbon compounds containing at least 20 total carbons per molecule, and encompasses all olefins, paraffins, and isomers having that number of carbon atoms.

Generally, at least a portion of the pyrolysis effluent, such as the pyrolysis gas stream, the pyrolysis oil steam, and/or the pyrolysis residue stream, may be routed to one or more other chemical processing facilities, including, for example, a cracking facility. In an embodiment or in combination with any embodiment mentioned herein, at least a portion of the pyrolysis effluent, such as the pyrolysis oil stream and/or the pyrolysis gas stream, may be routed to the cracker furnace of a cracking facility.

### Heat Integration with the Pyrolysis Flue Gas

As noted above, we have discovered that the carbon footprint of the chemical recycling facility 10 may be lowered by recycling residual heat from the pyrolysis flue gas back into the chemical recycling process. As shown in FIGS. 1-3, the chemical recycling facility 10 may utilize a convection box 16 to recover heat energy from the pyrolysis flue gas and transfer this heat energy to: (i) the waste plastic subjected to the plastic liquification process, (ii) the liquification system 12 and process, and/or (iii) the liquefied plastic stream from the plastic liquification system 12. Consequently, by recovering the heat energy from the pyrolysis flue gas, we have discovered that we can mitigate the need for combusting additional fossil fuels in order to generate sufficient heat energy for the processes occurring in the chemical recycling facility 10.

As noted above, the pyrolysis reactor 14 may be at least partially heated by a combustion system comprising a plurality a burners that combust a combustion fuel and a combustion air. Furthermore, as shown in FIGS. 1-3, this combustion system may produce a flue gas stream that can be removed from the pyrolysis reactor 14.

In an embodiment or in combination with any embodiment mentioned herein, upon exiting the pyrolysis reactor 14, the pyrolysis flue gas may have a temperature of at least 200° C., at least 250° C., at least 300° C., at least 350° C., at least 400° C., at least 450° C., at least 500° C., at least 550° C., at least 600° C., at least 650° C., at least 700° C., at least 750° C., at least 800° C., at least 850° C., at least 900° C., at least 950° C., or at least 1,000° C. Additionally, or in the alternative, upon exiting the pyrolysis reactor 14, the pyrolysis flue gas may have a temperature of not more than 1,500° C., not more than 1,400° C., not more than 1,300° C., not more than 1,200° C., not more than 1,100° C., not more than 1,000° C., not more than 900° C., not more than 800° C., not more than 700° C., or not more than 600° C. In certain embodiments, upon exiting the pyrolysis reactor 14, the pyrolysis flue gas may have a temperature in the range of 200 to 1,500° C., 400 to 1,300° C., 600 to 1,200° C., or 700 to 1,100° C.

After removal from the pyrolysis reactor 14, the pyrolysis flue gas may be introduced into a convection box 16 so as to facilitate the aforementioned heat exchange processes. The convection box 16 may comprise thermal insulation in order to help retain the heat energy provided by the pyrolysis flue gas. As used herein, the term “convection box” may be used interchangeably with the term “convection section” and these terms refer to an enclosed structure of a furnace with at least one feed inlet for the pyrolysis flue gas to flow through, at least one outlet for the pyrolysis gas, and space to facilitate one or more vessels and/or heat exchange pathways.

Different convection box 16 configurations are demonstrated in FIGS. 1-3 and each of these configurations are described in greater detail. It should be noted that all of the above description in regard to FIG. 1 is also relevant to the configurations depicted in FIGS. 2 and 3, unless otherwise noted.

As shown in FIG. 1, the chemical recycling facility 10 may place the liquification system 12, including the liquification vessel, inside the convection box 16. Furthermore, as shown in FIG. 1, the liquification system 12, including the liquification vessel, may comprise a plurality of fins 20 to increase the surface area of the liquification vessel for heat transfer purposes. As depicted in FIG. 1, the waste plastic feed may be introduced into the convection box 16 and then introduced into the liquification system 12, as described above. Moreover, in certain embodiments, at least a portion of the pyrolysis oil produced from the pyrolysis reactor 14 may be added to the waste plastic feed prior to and/or after the introduction of the waste plastic feed into the convection box 16. As demonstrated in FIG. 1, the waste plastic feed, along with the pyrolysis oil, may be fed into the convection box 16 and plastic liquification system 12 via gravity.

Due to its placement within the convection box 16, the plastic liquification system 12 may be at least partially heated via indirect heat exchange with the pyrolysis flue gas. Thus, the heat energy required for plastic liquification may be at least partially recovered from or entirely derived from the pyrolysis flue gas. More particularly, the sealed liquification system 12 and sealed feed pipelines into the liquification system 12 can be immersed in the pyrolysis flue gas while in the convection box 16. Consequently, this can cause the heat energy from the pyrolysis flue gas to transfer via indirect heat exchange to the liquification vessel in the plastic liquification system 12 and the waste plastic feed stream. Thus, the heat energy provided by the pyrolysis flue gas in the convection box 16 can be sufficient to at least partially melt the waste plastics in the feed stream.

In an embodiment or in combination with any embodiment mentioned herein, the liquefied waste plastic stream exiting the plastic liquification system 12 may have a temperature of at least 200, at least 225, at least 250, at least 275, at least 300, at least 310, at least 320, at least 330, or at least 340° C. and/or less than 450, less than 425, less than 400, less than 375, or less than 350° C.

As shown FIG. 1, after exiting the plastic liquification system 12, the liquefied plastic stream may be further heated by allowing the liquefied plastic stream to pass (via gravity and/or density difference) through one or more warming passes in the convection box 16 heated by the pyrolysis flue gas. While in these warming passes (shown as tubes 22 in FIG. 1), the liquefied waste plastic can be further heated via indirect heat exchange with the pyrolysis flue gas. Although FIG. 1 depicts multiple warming passes, it is envisioned that a single warming pass may be present in the convection or multiple warmings, depending on the size of the facility and the convection box 16, along with the desired temperature of the liquefied plastic stream. Furthermore, in various embodiments, the tubes 22 forming the warming passes may or may not comprise external fins 20 in order to increase the surface area of the warming pass tubes 22 within the convection box 16, thereby facilitating the heat exchange process.

Generally, these warming passes may be in the form a brazed aluminum heat exchanger comprising a plurality of warming passes disposed in the convection box 16 for facilitating indirect heat exchange between the liquefied plastic stream and the pyrolysis flue gas in the convection box 16. This additional heating step can take advantage of the excess heat energy provided by the pyrolysis flue gas. Consequently, the liquefied plastic stream may be further heated prior to the downstream pyrolysis process, thereby lowering the heat energy requirements of the pyrolysis reaction.

After indirect heat exchange within the warming passes, the heated liquefied plastic stream may increase in temperature. In an embodiment or in combination with any embodiment mentioned herein, after indirect heat exchange in the aforementioned warming passes, the temperature of the liquefied plastic stream can increase by at least 10, at least 25, at least 50, at least 75, at least 100, at least 125, at least 150, at least 175, or at least 200° C. and/or not more than 300, not more than 250, not more than 200, or not more than 150° C.

In an embodiment or in combination with any embodiment mentioned herein, the liquefied waste plastic stream 24 exiting the warming passes may have a temperature of at least 250, at least 275, at least 300, at least 325, at least 350, at least 375, at least 400, at least 425, or at least 450° C. and/or less than 700, less than 650, less than 600, less than 550, or less than 500° C.

As shown in FIG. 1, after exiting the warming passes, the heated liquefied plastic stream 24 may exit the convection box 16 and be introduced into the pyrolysis reactor 14 as described above.

In an embodiment or in combination with any embodiment mentioned herein, and as shown in FIG. 1, the convection box 16 may also be at least partially heated using secondary heat sources. The secondary heat source can be an electrical heater (e.g., an electric resistance heater and/or an induction heater) and/or an additional combustion system comprising a plurality a burners that combust a combustion fuel and a combustion air. In certain embodiments, the chemical recycling facility 10 does not use a secondary heat source for the convection box 16.

As shown in FIG. 2, an alternative convection box 16 configuration is provided. It should be noted that all of the relevant disclosure in regard to FIG. 1 is also applicable to the configuration depicted in FIG. 2, unless otherwise noted. Thus, the various ranges and conditions discussed in FIG. 1 are also applicable to FIG. 2, unless otherwise specified.

As shown in FIG. 2, the liquification system 12 is also placed in the convection box 16, like in FIG. 1. However, in FIG. 2, the liquefied plastic stream may be temporarily removed from the convection box 16 and introduced into a pump 26, which can then facilitate the movement of the liquefied plastic stream through the warming passes 22 in the convection box 16. Thus, in FIG. 2, the liquefied plastic stream may be pushed through the warming passes 22 via the pump 26; rather than by gravity alone.

FIG. 3 provides an alternative wherein the plastic liquification system 12 is placed outside of the convection box 16. In the configuration depicted in FIG. 3, the plastic liquification system 12 can still recover heat energy from the pyrolysis flue gas via a heat transfer medium loop 28 that runs through the convection box 16.

It should be noted that all of the relevant disclosure in regard to FIGS. 1 and 2 is also applicable to the configuration depicted in FIG. 3, unless otherwise noted. Thus, the various ranges and conditions discussed for FIGS. 1 and 2 are also applicable to FIG. 3, unless otherwise specified.

As shown in FIG. 3, the chemical recycling facility 10 may contain at least one heat transfer medium loop 28 containing at least one heat transfer medium that can transfer at least a portion of the heat energy from the pyrolysis flue gas back to the waste plastic feed stream upstream of and/or in the plastic liquification system 12. As discussed below in greater detail, the heat transfer media (HTM) may operate within a heat transfer medium loop 28, which contains the heat transfer medium. As shown in FIG. 3, while in the heat transfer medium loop 28, the heat transfer medium may be heated via indirect heat exchange with the pyrolysis flue gas.

As demonstrated in FIG. 3, the heat transfer medium in the heat transfer medium loop 28 may recover heat energy from at least a portion of the pyrolysis flue gas via multiple warming passes 30 within the convection box 16. While in these warming passes 30, the heat transfer medium can recover at least a portion of the heat energy from the pyrolysis flue gas via indirect heat exchange. The warming passes can comprise any conventional cross-flow heat exchangers known in the art, such as a transfer line exchanger. In certain embodiments, the heat exchangers may comprise a brazed aluminum heat exchanger comprising a plurality of cooling and warming passes (e.g., cores) disposed therein for facilitating indirect heat exchange between one or more process streams and at least one heat transfer medium stream.

After indirect heat exchange with the pyrolysis flue gas in the convection box 16, the temperature of the heat transfer medium in the heat transfer medium loop 28 can increase by at least 25, at least 50, at least 75, at least 100, at least 125, at least 150, at least 175, or at least 200° C. and/or not more than 400, not more than 350, not more than 300, or not more than 250° C.

In an embodiment or in combination with any embodiment mentioned herein, after indirect heat exchange with the pyrolysis flue gas in the convection box 16, the heated heat transfer medium may have a temperature of at least 150, at least 175, at least 200, at least 210, at least 220, at least 230, at least 240, at least 250, at least 260, at least 270, at least 280, at least 290, at least 300, at least 320, at least 340, at least 350, at least 360, at least 370, at least 380, at least 390, or at least 400° C. Additionally, or alternatively, after indirect heat exchange with the pyrolysis flue gas in the convection box 16, the heated heat transfer medium may have a temperature of less than 600, less than 550, less than 500, less than 450, less than 400, less than 390, less than 380, less than 370, less than 360, less than 350, less than 340, less than 330, less than 320, less than 310, less than 300, or less than 290° C. In various embodiments, after indirect heat exchange with the pyrolysis flue gas in the convection box 16, the heated heat transfer medium may have a temperature in the range of 200 to 600° C., 250 to 550° C., 290 to 500° C., or 300 to 450° C.

Turning again to FIG. 3, after withdrawing heat energy from the pyrolysis flue gas in the convection box 16, at least a portion of the heat transfer medium in the heat transfer medium loop 28 may be routed to the plastic liquification system 12. While in the liquification system 12, the heated heat transfer medium may provide heat energy to the plastic liquification processes described herein. For example, the liquification vessel (e.g., the melt tank, a CSTR, and/or extruder) may comprise: (i) internal coils through which the heated transfer medium can flow and/or (ii) external coils and/or jacketing that allows the heated heat transfer medium to flow therethrough and thereby provide heat energy to the plastic liquification process occurring in the liquification vessel.

In an embodiment or in combination with any embodiment mentioned herein, the heated heat transfer medium may provide heat energy via indirect heat exchange to the plastic liquification system 12 by: (i) routing the heated heat transfer medium through one or more internal coils within the liquification vessel (e.g., a melt tank, a CSTR, and/or an extruder); (ii) routing the heated heat transfer medium through one or more external coils outside of the liquification vessel (e.g., a melt tank, a CSTR, and/or an extruder); (iii) routing the heated heat transfer medium through a heating jacket positioned outside of the liquification vessel (e.g., a melt tank, a CSTR, and/or an extruder); and/or (iv) routing the heated heat transfer medium through an external heat exchanger (not shown) within the liquification system 12.

Additionally, or alternatively, the heated heat transfer medium may also provide heat energy to the waste plastic feed stream via indirect heat exchange in a heat exchanger, prior to introducing the waste plastic feed stream into the liquification system 12. Consequently, this can further heat the waste plastics in the waste plastic feed stream. Thus, due to its increased temperature, the heated the waste plastic feed stream can further facilitate the plastic liquification processes occurring in the liquification system 12.

The heat transfer medium can be any conventional heat transfer medium known in the art. In an embodiment or in combination with any embodiment mentioned herein, the heat transfer medium can be a non-aqueous fluid or an aqueous fluid (e.g., water and/or steam). The heat transfer medium may also be a single-phase medium (e.g., liquid or vapor) or a two-phase medium (e.g., liquid/vapor) while in the loop. In certain embodiments, the heat transfer medium may be in a liquid phase prior to heating (e.g., water) and then transition to another phase (e.g., steam) or a mixed phase (e.g., water/steam) upon heating.

Examples of suitable non-aqueous heat transfer media that can be used as the heat transfer medium includes an oil, a siloxane, a molten metal, a molten salt, or a combination thereof.

In an embodiment or in combination with any embodiment mentioned herein, the heat transfer medium comprises a non-aqueous heat transfer medium, such as a synthetic oil (e.g., THERMINOL®), a refined oil (e.g., a mineral oil), or a combination thereof. As used herein, a “refined oil” refers to a natural (i.e., non-synthetic) oil that has been subjected to a distillation and/or or purification step.

In an embodiment or in combination with any embodiment mentioned herein, the heat transfer medium comprises a molten salt. Exemplary molten salts include sodium chloride, sodium nitrate, potassium nitrate, or a combination thereof.

In an embodiment or in combination with any embodiment mentioned herein, the heat transfer medium comprises a molten metal. Exemplary molten metals can include lithium, gallium, sodium, cadmium, potassium, indium, lead, tin, bismuth, thallium, or a combination thereof.

In an embodiment or in combination with any embodiment mentioned herein, the heat transfer medium comprises an aqueous fluid, such as steam and/or water. If the heat transfer medium comprises steam, then the heat transfer medium loop may be in fluid communication with an HTM source, such as a steam generator, that provides the steam and/or water. In certain embodiments, the steam generator may generate the heat transfer medium from boiler feed water derived from the cracker facility. Additionally, or alternatively, the steam generator may also comprise a temperator for adding additional heat energy to the heat transfer medium that is provided.

In an embodiment or in combination with any embodiment mentioned herein, the heat transfer medium comprises steam. The steam can comprise a pressure of at least 300, at least 400, at least 500, at least 600, at least 700, at least 800, at least 900, at least 1,000, at least 1,100, at least 1,200, at least 1,300, at least 1,400, at least 1,500, or at least 1590 psi and/or less than 2,000, less than 1,800, less than 1,700, or less than 1,650 psig. In certain embodiments, the steam can comprise 1,600 psig steam.

After being removed from the convection box 16 in FIGS. 1-3, the cooled pyrolysis flue gas may have a temperature of not more than 300° C., not more than 250° C., not more than 200° C., not more than 150° C., or not more than 100° C.

After supplying the heat energy, the cooled pyrolysis flue gas may comprise some quantity of carbon dioxide and/or other components that are undesirable for downstream separations and/or other chemical recycling processes. Due to the cooling of the pyrolysis flue gas in the convection box 16, the cooled pyrolysis flue gas may be readily treated in a CO₂ Removal System 18 without any further cooling, so as to effectively recover at least a portion of the CO₂ in the cooled pyrolysis flue gas.

As shown in FIGS. 1-3, and if deemed necessary, the cooled pyrolysis flue gas exiting the convection box 16 may be further cooled with at least one heat exchanger 32 outside of the convection box 16 so as to further cool the stream prior to CO₂ removal.

In an embodiment or in combination with any embodiment mentioned herein, at least a portion of the cooled pyrolysis flue gas exiting the convection box 16 may be routed through an optional heat exchanger 32 so as to further cool the stream prior to further downstream processing. This heat exchanger 32 may utilize a heat transfer medium to remove heat energy from the cooled pyrolysis flue gas via indirect heat exchange. Any conventional heat exchange medium may be used. In certain embodiments, the heat exchange medium comprises steam, water, an oil, a siloxane, a molten metal, a molten salt, or a combination thereof.

In an embodiment or in combination with any embodiment mentioned herein, at least a portion of the cooled pyrolysis flue gas may be cooled via indirect heat exchange in the heat exchanger 32 to a temperature of not more than 100, not more than 75, or not more than 50° C. In certain embodiments, at least a portion of the cooled pyrolysis flue gas may be cooled via indirect heat exchange in the heat exchanger 32 to a temperature of 25 to 45 or 30 to 40° C.

It should be noted that this heat exchanger 32 can comprise any conventional cross-flow heat exchangers known in the art, such as a transfer line exchanger. In certain embodiments, the heat exchanger 32 may comprise a brazed aluminum heat exchanger comprising a plurality of cooling and warming passes (e.g., cores) disposed therein for facilitating indirect heat exchange between one or more process streams and at least one heat transfer medium stream. Although generally illustrated in FIGS. 1-3 as comprising a single core or “shell,” it should be understood that the heat exchangers can, in some embodiments, comprise two or more separate core or shells.

As shown in FIGS. 1-3, we have discovered that the carbon footprint of the chemical recycling facility 10 may be furthered lowered by recovering (e.g., via capturing and/or sequestering) CO₂ from at least a portion of the cooled pyrolysis flue gas. As shown in FIGS. 1-3, at least a portion the cooled pyrolysis flue gas may be introduced into a CO₂ Removal System 18 to yield a CO₂-depleted stream and a captured CO₂ stream. In certain embodiments, the CO₂ Removal System 18 can comprise a CO₂ absorber comprising at least one absorber tower and at least one stripper/regenerator tower.

While in the CO₂ Removal System 18, at least a portion of the cooled pyrolysis flue gas may be introduced into one or more absorber towers, where the stream(s) contact an absorber solvent (i.e., a lean absorber solvent) that is concurrently introduced into the one or more absorber towers. Upon contact, at least a portion of the carbon dioxide and/or other impurities in the cooled pyrolysis flue gas may be absorbed and removed in the resulting rich absorber solvent stream.

Generally, the absorber solvent can comprise an organic solvent. In an embodiment or in combination with any embodiment mentioned herein, the absorber solvent can comprise an absorbing component selected from the group consisting of amines, methanol, sodium hydroxide, sodium carbonate/bicarbonate, potassium hydroxide, potassium carbonate/bicarbonate, SELEXOL®, glycol ether, and combinations thereof.

The absorbing component may comprise an amine selected from the group consisting of diethanolamine (DEA), monoethanolamine (MEA), methyldiethanolamine (MDEA), diisopropanolamine (DIPA), diglycolamine (DGA), piperazine, modifications, derivatives, and combinations thereof.

The resulting CO₂-depleted stream exits the absorber tower(s) overhead and is generally depleted in carbon dioxide relative to the cooled pyrolysis flue gas fed into the absorber tower(s).

The absorbed carbon dioxide in the rich absorber solvent stream can be removed from the absorber solvent in the stripper/regeneration tower(s). Within the stripper/regeneration tower(s), the carbon dioxide can be stripped from the rich absorber solvent by contacting the solvent with water/steam. The recovered carbon dioxide gas may be removed as the captured CO₂ stream. After CO₂ removal, the resulting lean absorber solvent stream may be recycled back to the absorber tower.

As shown in FIGS. 1-3, at least a portion of the CO₂-depleted stream may be removed from the facility.

In an embodiment or in combination with any embodiment mentioned herein, the captured CO₂ stream is enriched in CO₂ concentration relative to the cooled pyrolysis flue gas. For example, the recovered CO₂ stream may comprise at least 30, at least 35, at least 40, at least 45, at least 50, at least 55, at least 60, at least 65, at least 70, at least 75, at least 80, at least 85, at least 90, at least 95, at least 96, at least 97, at least 98, or at least 99 percent of the CO₂ originally present in the cooled pyrolysis flue gas.

The captured CO₂ stream may be removed from the system and used to produce various end products (e.g., as a feedstock to synthesize various chemicals and food products, such as carbonation) and/or further processed in downstream facilities not depicted in FIGS. 1-3.

### Definitions

It should be understood that the following is not intended to be an exclusive list of defined terms. Other definitions may be provided in the foregoing description, such as, for example, when accompanying the use of a defined term in context.

As used herein, the terms “a,” “an,” and “the” mean one or more.

As used herein, the term “and/or,” when used in a list of two or more items, means that any one of the listed items can be employed by itself or any combination of two or more of the listed items can be employed. For example, if a composition is described as containing components A, B, and/or C, the composition can contain A alone; B alone; C alone; A and B in combination; A and C in combination, B and C in combination; or A, B, and C in combination.

As used herein, the phrase “at least a portion” includes at least a portion and up to and including the entire amount or time period.

As used herein, “aqueous” refers to a fluid containing at least five percent of molecular water by weight.

As used herein, the term “bottom” refers to the physical location of a structure that is below the other noted structures within an enclosed structure. For example, a “bottom” stream is a stream taken from a vessel at a position that is lower elevation-wise to other streams taken from the vessel, such as an “overhead” stream.

As used herein, the term “chemical recycling” refers to a waste plastic recycling process that includes a step of chemically converting waste plastic polymers into lower molecular weight polymers, oligomers, monomers, and/or non-polymeric molecules (e.g., hydrogen, carbon monoxide, methane, ethane, propane, ethylene, and propylene) that are useful by themselves and/or are useful as feedstocks to another chemical production process(es). As used herein, the term “chemical recycling facility” refers to a

facility for producing a recycle content product via chemical recycling of waste plastic.

As used herein, the term “co-located” refers to the characteristic of at least two objects being situated on a common physical site, and/or within one mile of each other.

As used herein, the terms “comprising,” “comprises,” and

“comprise” are open-ended transition terms used to transition from a subject recited before the term to one or more elements recited after the term, where the element or elements listed after the transition term are not necessarily the only elements that make up the subject.

As used herein, the term “cracking” refers to breaking down complex organic molecules into simpler molecules by the breaking of carbon-carbon bonds.

As used herein, the term “depleted” refers to having a concentration (on a dry weight basis) of a specific component that is less than the concentration of that component in a reference material or stream.

As used herein, the term “directly derived” refers to having at least one physical component originating from waste plastic.

As used herein, the term “enriched” refers to having a concentration (on a dry weight basis) of a specific component that is greater than the concentration of that component in a reference material or stream.

As used herein, the terms “exhaustion” or “exhausting” refer to methods for disposing of the specified stream by removing the stream from the facility. Exemplary exhaustion methods can include venting.

As used herein, the term “fluid” may encompass a liquid, a gas, a supercritical fluid, or a combination thereof.

As used herein, the term “halide” refers to a composition comprising a halogen atom bearing a negative charge (i.e., a halide ion).

As used herein, the term “halogen” or “halogens” refers to organic or inorganic compounds, ionic, or elemental species comprising at least one halogen atom.

As used herein, the terms “having,” “has,” and “have” have the same open-ended meaning as “comprising,” “comprises,” and “comprise” provided above.

As used herein, a “heat transfer medium loop” or “HTM loop” refers to a system comprising one or more heat exchangers through which a common HTM is circulated to a common HTM supply or a part of a larger system for the purpose of transferring heat and/or energy into and/or out of the chemical recycling process.

As used herein, the terms “including,” “include,” and “included” have the same open-ended meaning as “comprising,” “comprises,” and “comprise” provided above.

As used herein, the term “indirectly derived” refers to having an assigned recycle content i) that is attributable to waste plastic, but ii) that is not based on having a physical component originating from waste plastic.

As used herein, the term “isolated” refers to the characteristic of an object or objects being by itself or themselves and separate from other materials, in motion or static.

As used herein, the terms “mixed plastic waste” and “MPW” refer to a mixture of at least two types of waste plastics including, but not limited to the following plastic types: polyethylene terephthalate (PET), one or more polyolefins (PO), and polyvinylchloride (PVC).

As used herein, “non-aqueous” refers to a fluid containing less than five percent of molecular water by weight.

As used herein, the term “overhead” refers to the physical location of a structure that is above a maximum elevation of quantity of particulate plastic solids within an enclosed structure. For example, an “overhead” stream is a stream taken from a vessel at a position that is higher elevation-wise to other streams taken from the vessel, such as a “bottom” stream.

As used herein, the term “partially processed waste plastic” means waste plastic that has been subjected to at least on automated or mechanized sorting, washing, or comminuted step or process. Partially processed waste plastics may originate from, for example, municipal recycling facilities (MRFs) or reclaimers. When partially processed waste plastic is provided to the chemical recycling facility, one or more preprocessing steps may me skipped.

As used herein, the term “physical recycling” (also known as “mechanical recycling”) refers to a waste plastic recycling process that includes a step of melting waste plastic and forming the molten plastic into a new intermediate product (e.g., pellets or sheets) and/or a new end product (e.g., bottles). Generally, physical recycling does not substantially change the chemical structure of the plastic, although some degradation is possible.

As used herein, the term “plastic” may include any organic synthetic polymers that are solid at 25° C. and 1 atmosphere of pressure.

As used herein, the term “predominantly” means more than 50 percent by weight. For example, a predominantly propane stream, composition, feedstock, or product is a stream, composition, feedstock, or product that contains more than 50 weight percent propane.

As used herein, the term “preprocessing” refers to preparing waste plastic for chemical recycling using one or more of the following steps: (i) comminuting, (ii) particulating, (iii) washing, (iv) drying, and/or (v) separating.

As used herein, the term “pyrolysis” refers to thermal decomposition of a feedstock of a biomass and/or a plastic material in solid or liquid form at elevated temperatures in an inert (i.e., substantially molecular oxygen free) atmosphere.

As used herein, the term “pyrolysis char” refers to a carbon-containing composition obtained from pyrolysis that is solid at 200° C. and 1 atm.

As used herein, the terms “pyrolysis gas” and “pygas” refer to a composition obtained from pyrolysis that is gaseous at 25° C. at 1 atm.

As used herein, the term “pyrolysis heavy waxes” refers to C20+hydrocarbons obtained from pyrolysis that are not pyrolysis char, pyrolysis gas, or pyrolysis oil.

As used herein, the terms “pyrolysis oil” or “pyoil” refers to a composition obtained from pyrolysis that is liquid at 25° C. and 1 atm.

As used herein, the term “pyrolysis residue” refers to a composition obtained from pyrolysis that is not pyrolysis gas or pyrolysis oil and that comprises predominantly pyrolysis char and pyrolysis heavy waxes.

As used herein, the terms “recycle content” and “r-content” refer to being or comprising a composition that is directly and/or indirectly derived from waste plastic.

As used herein, the terms “r-pyrolysis gas” or “r-pygas” refer to being or comprising a pyrolysis gas that is directly and/or indirectly derived from waste plastic.

As used herein, the terms “r-pyrolysis oil” or “r-pyoil” refer to being or comprising a pyrolysis oil that is directly and/or indirectly derived from waste plastic.

As used herein, the term “residual” refers to a remaining quantity or amount of an identified product or component that remains from an original source containing the product or component. For example, a “residual pyrolysis oil” may refer to the remaining pyrolysis oil from an initial pyrolysis effluent after the majority of the pyrolysis oil has been previously removed therefrom.

As used herein, the terms “waste plastic” and “plastic waste” refer to used, scrap, and/or discarded plastic materials. The waste plastic fed to the chemical recycling facility may be unprocessed or partially processed.

As used herein, the term “unprocessed waste plastic” means waste plastic that has not be subjected to any automated or mechanized sorting, washing, or comminuting. Examples of unprocessed waste plastic include waste plastic collected from household curbside plastic recycling bins or shared community plastic recycling containers.

As used herein, “downstream” means a target unit operation, vessel, or equipment that:
a. is in fluid (liquid or gas) communication, or in piping communication, with an outlet stream from the radiant section of a cracker furnace, optionally through one or more intermediate unit operations, vessels, or equipment, or
b. was in fluid (liquid or gas) communication, or in piping communication, with an outlet stream from the radiant section of a cracker furnace, optionally through one or more intermediate unit operations, vessels, or equipment, provided that the target unit operation, vessel, or equipment remains within the battery limits of the cracker facility (which includes the furnace and all associated downstream separation equipment).

### CLAIMS NOT LIMITED TO DISCLOSED EMBODIMENTS

When a numerical sequence is indicated, it is to be understood that each number is modified the same as the first number or last number in the numerical sequence or in the sentence, e.g., each number is “at least,” or “up to” or “not more than” as the case may be; and each number is in an “or” relationship. For example, “at least 10, 20, 30, 40, 50, 75 wt. % . . . ” means the same as “at least 10 wt. %, or at least 20 wt. %, or at least 30 wt. %, or at least 40 wt. %, or at least 50 wt. %, or at least 75 wt. %,” etc.; and “not more than 90 wt. %, 85, 70, 60 . . . ” means the same as “not more than 90 wt. %, or not more than 85 wt. %, or not more than 70 wt. % . . . ” etc.; and “at least 1%, 2%, 3%, 4%, 5%, 6%, 7%, 8%, 9% or 10% by weight . . . ” means the same as “at least 1 wt. %, or at least 2 wt. %, or at least 3 wt. % . . . ” etc.; and “at least 5, 10, 15, 20 and/or not more than 99, 95, 90 weight percent” means the same as “at least 5 wt. %, or at least 10 wt. %, or at least 15 wt. % or at least 20 wt. % and/or not more than 99 wt. %, or not more than 95 wt. %, or not more than 90 weight percent . . . ” etc.

The preferred forms of the invention described above are to be used as illustration only and should not be used in a limiting sense to interpret the scope of the present invention. Modifications to the exemplary embodiments, set forth above, could be readily made by those skilled in the art without departing from the spirit of the present invention.

The inventors hereby state their intent to rely on the Doctrine of Equivalents to determine and assess the reasonably fair scope of the present invention as it pertains to any apparatus not materially departing from but outside the literal scope of the invention as set forth in the following claims.

1. A chemical recycling process comprising:
(a) pyrolyzing a feedstock comprising a liquefied waste plastic to produce a pyrolysis effluent stream, wherein the pyrolyzing comprises combusting a pyrolysis fuel to thereby form a pyrolysis flue gas and provide heat for the pyrolyzing;
(b) liquefying at least a portion of a waste plastic with the application of heat in a liquification system to form the liquefied waste plastic, wherein at least a portion of the heat used for the liquefying of the waste plastic is recovered from the pyrolysis flue gas; and
(c) further heating at least a portion of the liquefied waste plastic, wherein at least a portion of the heat used for the further heating is recovered from the pyrolysis flue gas.

2. The process according to claim 1, wherein the liquefying of step (b) occurs in a convection section through which at least a portion of the pyrolysis flue gas passes, wherein the liquification system is located in the convection section.

3. The process according to claim 1, further comprising providing a convection section through which at least a portion of the pyrolysis flue gas passes, wherein the liquification system is located outside of the convection section.

4. The process according to claim 1, wherein the liquefying of step (b) comprises melting at least a portion of the waste plastic.

5. The process according to claim 1, wherein the further heating step comprises passing the liquefied waste plastic through a plurality of tubes in a convection section.

6. The process according to claim 1, further comprising providing a heat transfer medium loop containing at least one heat transfer medium, wherein at least a portion of the heat used for the liquefying of step (b) is recovered from the heat transfer medium.

7. The process according to claim 6, wherein the heat transfer medium comprises steam.

8. The process according to claim 6, wherein the heat transfer medium comprises an oil.

9. The process according to claim 6, further comprising heating at least a portion of the heat transfer medium via indirect heat exchange with the pyrolysis flue gas to form a heated heat transfer medium.

10. The process according to claim 1, wherein the further heating step forms a heated liquefied waste plastic stream having a temperature of at least 300° C.

11. A chemical recycling process comprising:
(a) pyrolyzing a feedstock comprising a liquefied waste plastic to produce a pyrolysis effluent stream, wherein the pyrolyzing comprises combusting a pyrolysis fuel to thereby form a pyrolysis flue gas and provide heat for the pyrolyzing;
(b) liquefying at least a portion of a waste plastic in a liquification system to form the liquefied waste plastic and a halogen-containing waste stream, wherein at least a portion of the heat used for the liquefying of the waste plastic is recovered from the pyrolysis flue gas;
(c) further heating at least a portion of the liquefied waste plastic in a convection section, wherein at least a portion of the heat used for the further heating is recovered from the pyrolysis flue gas; and
(d) recovering a carbon dioxide stream from at least a portion of the pyrolysis flue gas after the liquefying of step (b) and the further heating of step (c).

12. The process according to claim 11, wherein the liquification system comprises at least one melt tank.

13. The process according to claim 11, further comprising providing a pump for facilitating movement of the liquefied waste plastic, and wherein the further heating step comprises passing the liquefied waste plastic through a plurality of tubes in a convection section.

14. The process according to claim 11, wherein the heat transfer medium comprises steam or oil.

15. The process according to claim 11, further comprising heating at least a portion of the heat transfer medium via indirect heat exchange with the pyrolysis flue gas to form a heated heat transfer medium.

16. The process according to claim 11 wherein the liquefied waste plastic stream exiting the liquification system has a temperature of at least 200, at least 225, at least 250, at least 275, at least 300, at least 310, at least 320, at least 330, or at least 340° C. and/or less than 450, less than 425, less than 400, less than 375, or less than 350° C.

17. The process according to claim 11, wherein the further heating step forms a heated liquefied waste plastic stream having a temperature of at least 250, at least 275, at least 300, at least 325, at least 350, at least 375, at least 400, at least 425, or at least 450° C. and/or less than 700, less than 650, less than 600, less than 550, or less than 500° C.
